(19) United States
(12) Patent Application Publication
(10) Pub. No.: US 2008/0076845 A1
(43) Pub. Date: Mar. 27, 2008

(54) Method of Manufacturing Optical Information Recording Medium

(75) Inventor: Yoshihisa Usami, Kanagawa (JP)

Correspondence Address: TAIYO CORPORATION, 401 HOLLAND LANE, #407, ALEXANDRIA, VA, 22314, US

(73) Assignee: FUJIFILM Corporation, Minato-ku, Tokyo (JP)

(21) Appl. No.: 11/662,660

(22) PCT Filed: Sep. 12, 2005
(86) PCT No.: PCT/JP05/17203

§ 371 Date: Aug. 28, 2007

(30) Foreign Application Priority Data
Sep. 14, 2004 (JP) 2004-267446

(51) Int. Cl. C08F 2/48

(52) U.S. Cl. 522/4

(57) ABSTRACT

The present invention provides a method of manufacturing an optical information recording medium having a cured layer of an ultraviolet-curable resin, including a treatment of irradiating a layer of the ultraviolet-curable resin with ultraviolet rays emitted from light emitting diodes having a light emitting wavelength peak of 380 nm or less to cure the ultraviolet-curable resin.

### TECHNICAL FIELD

The present invention relates to a method of manufacturing an optical information recording medium. More particularly, the present invention relates to a method of manufacturing an optical information recording medium having a cured layer which is formed by curing an ultraviolet-curable resin.

### BACKGROUND ART

Conventionally, a WORM (write once, read many)-type optical information recording medium (optical disk) in which one-time information recording using laser light is enabled is referred to as a “CD-R”, and widely known. A CDR-type optical information recording medium is typically structured such that a recording layer including an organic dye, a reflective layer made of a metal such as gold, and a resinous protective layer are sequentially laminated on a transparent disk-shaped substrate. Information recording in an optical disk is carried out as follows. The optical disk is irradiated with near-infrared rays (ordinarily, laser light having a wavelength of about 780 nm). The irradiated light (laser light) is absorbed by the portion of the recording layer which has been irradiated with the light. The temperature at this portion of the recording layer is increased locally. Due to physical or chemical change (e.g., pit generation), optical characteristics of the portion of the recording layer are changed to record information in the optical disk. On the other hand, information reproduction is carried out ordinarily by irradiating the optical disk with laser light whose wavelength is the same as that of the laser light for recording and by detecting a reflectance difference between a portion of the recording layer at which optical characteristics have been changed (recorded portion) and a portion thereof at which optical characteristics have not been changed (unrecorded portion).

As a medium enabling higher density information recording than the CD-R, another WORM-type optical disk, which is referred to as a DVD-R, has lately been put to practical use, and has taken the position of large capacity recording medium. The DVD-R ordinarily has a structure wherein two disks, each of which is formed by laminating a recording layer including an organic dye, a reflective layer, and a protective layer on a transparent disk-shaped substrate in this order, are adhered to each other using an adhesive with the recording layer disposed at the inner side, or a structure wherein one such disk and a disk-shaped protective substrate having the same shape as the disk are adhered to each other using an adhesive with the recording layer disposed at the inner side. Further, these days, a blue ray disk and an HD DVD which allows for information recording and information reproduction by the irradiation of laser light having a shorter wavelength of 500 nm or less are also commercially available.

An ultraviolet-curable resin is generally used for the formation of a protective layer or the adhesion of disks as described above. An ultraviolet lamp such as a mercury lamp or a metal halide lamp is used as a light source when the ultraviolet-curable resin is cured, (see Japanese Patent Application (JP-A) No. 2002-358698, for example). However, when an ultraviolet lamp is used as a light source, the quantity of light of ultraviolet rays with which the outer circumferential portion of the disk is irradiated may be smaller than that with which the inner circumferential portion of the disk is irradiated. Therefore, unevenness of irradiation may occur. Further, since heat is generated during the irradiation of ultraviolet rays, warping of the substrate may occur. Moreover, the lamp has a short life.

Consequently, there is a need for a method of manufacturing an optical information recording medium in which an ultraviolet-curable resin layer can be irradiated uniformly with ultraviolet rays and thereby cured efficiently without causing any drawbacks such as warping.

### DISCLOSURE OF INVENTION

The need can be met by the following invention.

The invention provides a method of manufacturing an optical information recording medium having a cured layer of an ultraviolet-curable resin, including a treatment of irradiating a layer of the ultraviolet-curable resin with ultraviolet rays emitted from light emitting diodes having a light emitting wavelength peak of 380 nm or less to cure the ultraviolet-curable resin.

The invention can provide a method of manufacturing an optical information recording medium in which a layer of an ultraviolet-curable resin can be uniformly irradiated with ultraviolet rays and thereby cured efficiently without any drawbacks such as warping.

### BRIEF DESCRIPTION OF DRAWINGS

FIG. 1 is a plan view schematically showing an example of layout of LEDs in a curing treatment; and

FIG. 2 is a partial cross-sectional view schematically showing the example of the layout of the LEDs in the curing treatment.

### BEST MODE FOR CARRYING OUT THE INVENTION

The method of manufacturing an optical information recording medium of the invention is applied to production of an optical information recording medium having a cured layer of an ultraviolet-curable resin without particular limitations. Examples of the layer structure of the optical information recording medium include: (1) a blue-ray disk-type structure having a substrate, a reflective layer, a recording layer, an adhesive layer, and an transparent sheet in this order, (2) a CD-type structure having a substrate, a recording layer, a reflective layer, and a light-transmitting layer in this order, and (3) a DVD or HD DVD-type structure in which laminated bodies each having a substrate, a recording layer and a reflective layer in this order, are adhered to each other using an adhesive with the recording layer disposed at the inner side, or one such laminated body and a protective substrate are adhered to each other with the recording layer disposed at the inner side. Examples of the recording format include a Read-Only-type one, a WORM (write once, read many)-type one, and a Rewritable-type one.

The adhesive layer or the light-transmitting layer of the optical information recording medium is often formed by curing an ultraviolet-curable resin. Ordinarily, an ultraviolet lamp is used for the curing treatment of the adhesive layer or the light-transmitting layer including an ultraviolet-curable resin (hereinafter, the adhesive or light-transmitting layer is sometimes referred to as “a layer or a cured layer of an ultraviolet-curable resin”). On the other hand, a curing treatment in which a layer of an ultraviolet-curable resin is irradiated with ultraviolet rays emitted from light emitting diodes (LEDs) having a light emitting wavelength peak of 380 nm or less to cure the ultraviolet-curable resin is adopted in the invention.

Since the amount of heat generated by an LED is smaller than that generated by an ultraviolet lamp, use of the LED can prevent warping of the substrate due to heat. Further, use of a plurality of LEDs enables the layer of the ultraviolet-curable resin to be uniformly irradiated with ultraviolet rays and thereby cured efficiently. Moreover, LEDs have advantages of long life and inexpensiveness of the driving circuit. Furthermore, considering that LEDs do not produce ozone, use of the LEDs is also significant from an environmental aspect. LEDs are commercially available from Nichia Chemical Co., Ltd.

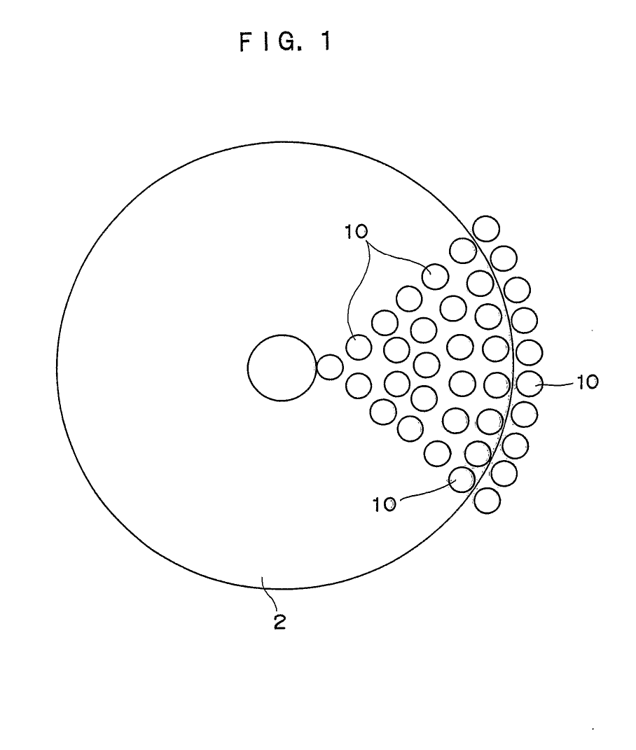

As shown in FIG. 1, LEDs are preferably arranged such that the number of LEDs is increased from the inner circumferential side of a laminated body 2 to an outer circumferential side of the laminated body 2. It is preferable that LEDs 10 are so arranged as to simultaneously irradiate the entire surface of the laminated body 2 with light emitted therefrom. However, as shown in FIG. 1, LEDs 10 may be arranged at a portion of the laminated body 2 such that the number of LEDs 10 is increased from the inner circumferential side to the outer circumferential side of the laminated body 2. In this case, the laminated body 2 is preferably rotated at a rotational velocity in the range of 1 to 10,000 rpm (preferably, 10 to 1000 rpm) when the laminated body is being irradiated with ultraviolet rays. In conventional methods in which a laminated body is irradiated with light emitted from an ultraviolet lamp, it is difficult to uniformly irradiate the entire surface of the laminated body with ultraviolet rays. Therefore, unevenness of irradiation may occur particularly between the inner circumferential side and the outer circumferential side of the laminated body 2. In contrast, by arranging LEDs 10 at a portion of the laminated body 2 such that the number of LEDs 10 is increased from the inner circumferential side to the outer circumferential side of the laminated body 2 and by irradiating the laminated body 2 with ultraviolet rays while rotating the laminated body 2, unevenness of time when the laminated body 2 is irradiated with ultraviolet rays can be eliminated from the inner circumferential side to the outer circumferential side of the laminated body 2. Therefore, a cured layer of the ultraviolet-curable resin with high film quality can be formed. Further, the number of LEDs 10 arranged only at a portion of the laminated body 2 can be smaller that that arranged at the entire portion of the laminated body 2, whereby the manufacturing cost of the laminated body 2 can be reduced.

The arrangement in which LEDs are arranged such that the number of LEDs is increased from the inner circumferential side to the outer circumferential side of the laminated body 2 need to enable uniform irradiation of ultraviolet rays and otherwise it is not particularly limited. However, the number of LEDs in an inner circumferential region (a region in the radium range of 15 to 30 mm from the center of the laminated body 2), the number of LEDs in an intermediate circumferential region (a region in the radium range of 30 to 45 mm from the center), and the number of LEDs in an outer circumferential region (a region in the radium range of 45 to 60 mm from the center) preferably satisfy the following relationships of “the number of LEDs in the inner circumferential region/that in the intermediate circumferential region of 1/1.5 to 1/4 (more preferably, 1/1.8 to 1/3), “the number of LEDs in the intermediate circumferential region/that in the outer circumferential region of 1/1.2 to 1/3 (more preferably, 1/1.5 to 1/2.5). This arrangement can enhance the effect of uniformly irradiating the entire of the laminated body 2, from the inner circumferential side to the outer circumferential side thereof, with ultraviolet rays.

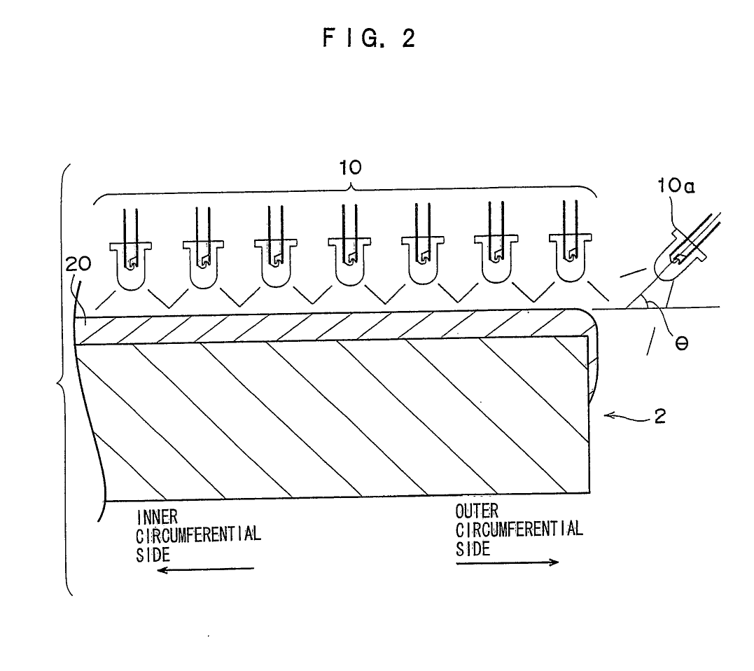

As shown in FIG. 2, the LEDs 10 can be provided so that the direction in which each of the LEDs 10 emits ultraviolet rays is substantially perpendicular to the surface of the laminated body 2 (the angle between the above direction and the surface of the laminated body 2 is almost 90°). However, as shown in FIG. 2, at least one LED 10a provided at the outermost circumferential side of the laminated body 2 is preferably inclined to the surface of the laminated body 2 at a fixed angle so as to irradiate the end surface (side surface, or, in FIG. 2, vertical surface) of a layer 20 of an ultraviolet-curable resin with ultraviolet rays. The irradiation of ultraviolet rays in the direction substantially perpendicular to the (horizontal) surface of the layer 20 of an ultraviolet-curable resin is unlikely to irradiate the end surface of the layer 20 of an ultraviolet-curable resin with ultraviolet rays. Therefore, unevenness of irradiation may occur. In contrast, when the end surface is irradiated with ultraviolet rays emitted from the LED 10a inclined at a fixed angle as shown in FIG. 2, the end surface can be cured efficiently. The light emitting angle in this case (the angle θ in FIG. 2, or the angle formed between the surface of the layer 20 of an ultraviolet-curable resin and the direction in which LED 10a emits ultraviolet rays) is preferably 0 to 60°, and more preferably 20 to 50°. Further, when a transparent sheet or a protective substrate is bonded to the layer 20 of an ultraviolet-curable resin, they are irradiated with ultraviolet rays from the top surface thereof.

As an example of the method of manufacturing an optical information recording medium of the invention, a method of manufacturing a WORM (write once, read many)-type blue ray disk will be described. A WORM-type blue ray disk is manufactured through step (1) of fabricating a laminated body and step (2) of bonding. The curing treatment described above is conducted during the step of bonding. Hereinafter, each of the steps (1) and (2) will be explained.

(1) Step of Fabricating Laminated Body

A laminated body having a recording layer on a substrate is manufactured through the step of fabricating a laminated body. More specifically, the laminated body is fabricated through a “step of forming a recording layer” and other steps. In the step of forming a recording layer, a recording layer in which information can be recorded with laser light having a wavelength of 500 nm or less is formed on a substrate with a central hole and a groove having a track pitch of 200 to 400 nm and a groove depth of 10 to 150 nm. A “step of forming a reflective layer” in which a reflective layer is formed between a substrate and a recording layer and a step in which any other layer such as a barrier layer is formed on a recording layer can be suitably employed as other steps. Hereinafter, as a specific example of the step of fabricating a laminated body, a method of manufacturing a laminated body having a reflective layer and a recording layer on a substrate will be explained.

Step of Forming Reflective Layer

In the step of forming a reflective layer, a reflective layer containing a light reflective substance is formed on the groove-formed surface of a substrate, which will be described later.

The material of the substrate can be selected from various materials which are used as materials of substrates for conventional optical information recording media.

Specific examples thereof include: glass; polycarbonate; an acrylic resin such as polymethyl methacrylate; a vinyl chloride resin such as polyvinyl chloride and a vinyl chloride copolymer; an epoxy resin; amorphous polyolefin; polyester; and metal such as aluminum. Two or more of these materials can be used together, as necessary.

Among the aforementioned materials, from the standpoints of moisture proofness, dimensional stability, and low cost performance, the substrate is preferably made of amorphous polyolefin or polycarbonate, and is more preferably made of polycarbonate. Further, the thickness of the substrate is preferably 1.1±0.3 mm.

A guide groove for tracking or an irregularity (groove) representing information such as address signals is formed on the surface of the substrate. The track pitch of the pre-groove is in the range of 200 to 400 nm, and preferably in the range of 250 to 350 nm. Further, the depth of the pre-groove (groove depth) is in the range of 10 to 150 nm, and preferably in the range of 50 to 100 nm. By providing the groove having the track pitch and groove depth described above, the WORM-type blue ray disk can have higher recording density than a conventional CD-R (compact disk) or DVD-R (digital versatile disk).

Further, for the purposes to improve planarity and increase adhesiveness, an undercoat layer is preferably formed on the surface of the substrate on which surface a reflective layer is to be provided. Examples of the material of the undercoat layer include: high molecular substances such as polymethyl methacrylate, an acrylic acid-methacrylic acid copolymer, a styrene-maleic anhydride copolymer, polyvinyl alcohol, N-methylolacrylic amide, a styrene-vinyltoluene copolymer, chlorosulfonated polyethylene, nitrocellulose, polyvinyl chloride, chlorinated polyolefin, polyester, polyimide, a vinyl acetate-vinyl chloride copolymer, an ethylene-vinyl acetate copolymer, polyethylene, polypropylene and polycarbonate; and a surface modifier such as a silane coupling agent.

The undercoat layer is formed by dissolving or dispersing the above-described material in a suitable solvent to prepare a coating liquid, followed by coating the coating liquid on a substrate by a coating method such as a spin coating method, a dip coating method, or an extrusion coating method. The thickness of the undercoat layer is generally in the range of 0.005 to 20 μm, and preferably in the range of 0.01 to 10 μm.

A reflective layer is formed on a substrate through vapor-depositing, sputtering or ion-plating a light reflective substance having high reflectance with respect to laser light. The thickness of the reflective layer is in the range of 10 to 300 μm, and preferably in the range of 50 to 200 μm. Further, the reflectance of the reflective layer is preferably 70% or more.

Examples of the light reflective material having high reflectance include metals and semi-metals, such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn and Bi; and stainless steel. These light reflective materials may be used alone, or two or more of them can be used together or may be used in the form of alloy. Among these examples, the light reflective material is preferably Cr, Ni, Pt, Cu, Ag, Au, Al and/or stainless steel. The light reflective material is more preferably Au, Ag and/or Al, and/or an alloy thereof, and most preferably Au and/or Ag, and/or an alloy thereof.

Step of Forming Recording Layer

In the step of forming a recording layer, a layer (recording layer) in which information can be recorded with laser light having a wavelength of 500 nm or less is formed on the reflective layer. It is preferable that the recording layer contains a colorant or a dye as a recording substance.

The dye to be contained in the recording layer need to allow information to be recorded in the recording layer with laser light having a wavelength of 500 nm or less, and otherwise it is not particularly limited. Examples thereof include a cyanine dye, an oxonol dye, a metal complex dye, an azo dye, and a phthalocyanine dye.

Moreover, dyes described in JP-A Nos. 4-74690, 8-127174, 11-53758, 11-334204, 11-334205, 11-334206, 11-334207, 2000-43423, 2000-108513, and 2000-1558818 can also be used.

The recording layer is formed by dissolving a recording substance such as a dye, and optionally a binder and any other compound in a suitable solvent to prepare a coating solution, coating the coating solution on the reflective layer formed on the surface of the substrate to form a coating film, and drying the coating film. The concentration of the recording substance in the coating solution is generally in the range of 0.01 to 15% by mass, preferably in the range of 0.1 to 10% by mass, more preferably in the range of 0.5 to 5% by mass, and most preferably in the range of 0.5 to 3% by mass.

Examples of the solvent in the coating solution include esters such as butyl acetate, ethyl lactate and cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, iso-propanol, n-butanol, and diacetone alcohol; fluorine-containing solvents such as 2,2,3,3-tetrafluoropropanol; and glycol ethers such as ethylene glycol monomethyl ether, ethylene glycol monoethyl ether, and propylene glycol monomethyl ether.

These solvents can be used alone, or two or more of them can be used together, considering the solubility of the recording substance to be used. Furthermore, the coating solution may contain any other additive such as an antioxidant, a UV absorbent, a plasticizer and/or a lubricant according to purpose.

When the coating solution includes a binder, examples thereof include natural organic polymeric materials such as gelatin, cellulose derivatives, dextran, rosin, and rubber; and synthetic organic polymers, including hydrocarbon resins such as polyethylene, polypropylene, polystyrene, and polyisobutylene, vinyl resins such as polyvinyl chloride, polyvinylidene chloride, and vinyl chloride-vinyl acetate copolymer, acrylic resins such as polymethyl acrylate, and polymethyl methacrylate, polyvinyl alcohol, chlorinated polyethylene, epoxy resin, butyral resin, rubber derivatives, and initial condensates of thermosetting resins such as phenol-formaldehyde resin. When the recording layer includes a binder, the mass of the binder is generally from 0.01 to 50 times, and preferably from 0.1 to 5 times the mass of the recording substance. The concentration of the recording substance in the coating solution is generally from 0.01 to 10% by mass, and preferably from 0.1 to 5% by mass.

The coating method can be a spraying method, a spin-coating method, a dipping method, a roll-coating method, a blade-coating method, and a doctor-rolling method, or a screen-printing method. The recording layer can be a single layer or a multi-layer. Further, the thickness of the recording layer is generally in the range of 20 to 500 nm, preferably in the range of 30 to 300 nm, and more preferably in the range of 50 to 100 nm.

The recording layer may contain any anti-color fading agent to improve the light fastness thereof. As the anti-color fading agent, a singlet oxygen quencher is generally used. The singlet oxygen quencher can be at least one of those described in known publications such as patent specifications.

Specific examples thereof include singlet oxygen quenchers described in JP-A Nos. 58-175693, 59-81194, 60-18387, 60-19586, 60-19587, 60-35054, 60-36190, 60-36191, 60-44554, 60-44555, 60-44389, 60-44390, 60-54892, 60-47069, 63-209995, and 4-25492, and Japanese Patent Application Publication (JP-B) Nos. 1-38680 and 6-26028, DE Patent No. 350399, and the Journal of the Chemical Society of Japan, 1992, October, p. 1141.

The amount of the anti-color fading agent, for example, the singlet oxygen quencher is usually from 0.1 to 50% by mass, preferably from 0.5 to 45% by mass, more preferably from 3 to 40% by mass, and even more preferably from 5 to 25% by mass of the dye.

After the recording layer has been formed, a layer made of an oxide, a nitride, a carbide and/or a sulfide including at least one of Zn, Si, Ti, Te, Sm, Mo, and Ge can be formed as a barrier layer. The material of the barrier layer can be hybridized one such as ZnS—SiO₂. The barrier layer can be formed trough sputtering, vapor deposition, or ion-plating, and the thickness of the barrier layer is preferably 1 to 100 nm.

Thus, a laminated body having a reflective layer and a recording layer can be manufactured.

(2) Step of Bonding:

In the step of bonding, a transparent sheet serving as a cover sheet is bonded to the recording layer of the laminated body to protect the inside of an optical information-recording medium such as the recording layer. The transparent sheet and the laminated body are preferably bonded to each other with an adhesive (a cured layer of an ultraviolet-curable resin).

Here, the transparent sheet is made of a transparent material and otherwise it is not particularly limited. Typical examples of the transparent material include polycarbonate, cellulose triacetate, polymethyl methacrylate, and polyvinyl chloride.

The term “transparent” means having a property of transmitting light for recording and light for reproduction (transmittance: 90% or more).

The thickness of the transparent sheet is preferably in the range of 0.03 to 0.15 mm, more preferably in the range of 0.05 to 0.10 mm, and even more preferably in the range of 0.07 to 0.098 mm. The transparent sheet having a thickness within such ranges is easy to handle during the step of bonding, and can suppress coma aberration.

Bonding is carried out as follows. First, a predetermined amount of an ultraviolet-curable resin serving as an adhesive is coated on the surface of a laminated body to which surface a transparent sheet is to be bonded (such as a recording layer), and the transparent sheet is disposed on the surface. Thereafter, the ultraviolet-curable resin is uniformly spread between the laminated body and the transparent sheet by spin-coating. Next, the aforementioned curing treatment (treatment in which a layer of an ultraviolet-curable resin is irradiated with ultraviolet rays emitted from LEDs having a light emitting wavelength peak of 380 nm or less) is conducted to cure the layer of an ultraviolet-curable resin and to hence bond the laminated body and the transparent sheet.

The amount of the ultraviolet-curable resin to be coated is controlled so that the thickness of a cured layer of the ultraviolet-curable resin which cured layer is finally formed is in the range of 0.1 to 100 μm, preferably in the range of 2 to 50 μm, and more preferably in the range of 5 to 30 μm.

The ultraviolet-curable resin can be used as it is, and supplied from a dispenser to the surface of the laminated body. Alternatively, the ultraviolet-curable resin can be dissolved in a suitable solvent such as methyl ethyl ketone or ethyl acetate to prepare a coating solution, and the coating solution can be supplied from a dispenser to the surface of the laminated body. In order to prevent warping of an optical information recording medium, the ultraviolet-curable resin for forming a layer of an ultraviolet-curable resin preferably has a low shrinkage percentage at the time of curing. Such an ultraviolet-curable resin can be SD-640™ manufactured by Dainippon Ink and Chemicals, Incorporated.

During the bonding of the transparent sheet and the laminated body, atmosphere temperature is preferably 18° C. or more and atmosphere moisture (relative moisture) (Hereinafter, the atmosphere moisture means the same) is preferably 32% RH or more. When the atmosphere temperature is below 18° C. or when the atmosphere moisture is below 32% RH, curing reaction does not chemically or physically progress to such a degree that suffices for the bonding. Moreover, when the transparent sheet and the laminated body are left to stand at ordinary temperature and at ordinary moisture, stress may be eased, which may cause warping of an optical information recording medium, and whereby the optical information recording medium cannot be put into practical use. Also, when a dye is contained in the recording layer, recording characteristics may be adversely affected by this stress.

The atmosphere temperature is preferably 20° C. or more, more preferably 22° C. or more, and still more preferably 23° C. or more. On the other hand, the atmosphere moisture is preferably 35% RH or more, and more preferably 38% RH or more.

When the atmosphere temperature is too high, degeneration of an adhesive or sticker may occur, optical characteristics of an optical information recording medium may change, and warping of the optical information recording medium may occur at the time that the atmosphere temperature is restored to ordinary temperature. In particular, when a dye is contained in the recording layer, changes in recording characteristics may become considerable. This is because the moisture content of the dye may become high, which may adversely affect recording characteristics. Accordingly, the upper limit of the temperature is preferably 50° C. or less, more preferably 40° C. or less, and still more preferably 35° C. or less.

On the other hand, when the atmosphere moisture is too high, bedewing may occur at a portion of a device, and warping of an optical information recording medium may occur at the time that the atmosphere moisture is restored to ordinary moisture. Accordingly, the upper limit of the atmosphere moisture is preferably 80% RH or less, more preferably 70% RH or less, and still more preferably 65% RH or less.

Thus, a WORM-type blue ray disk is manufactured. However, the invention is not limited by the descriptions of the above-described method of manufacturing a WORM-type blue ray disk as long as the recited curing treatment can be conducted. The curing treatment can be applied to a case where a hard coat layer made of an ultraviolet-curable resin is further provided on a transparent sheet.

Further, the manufacturing method of the invention, and in particular, the curing treatment can be applied to a case where an optical information recording medium to be produced is a compact disk (CD), such as CD-R, having a light-transmitting layer including an ultraviolet-curable resin. Further, the curing treatment can also be applied to a case where an optical information recording medium to be produced is a digital versatile disk (DVD) or an HD DVD-type one which is formed by adhering laminated bodies to each other or by adhering a laminated body and a protective substrate to each other with an ultraviolet-curable resin layer serving as an adhesive layer.

1. A method of manufacturing an optical information recording medium having a cured layer of an ultraviolet-curable resin, comprising a treatment of irradiating a layer of the ultraviolet-curable resin with ultraviolet rays emitted from light emitting diodes having a light emitting wavelength peak of 380 nm or less to cure the ultraviolet-curable resin,
wherein an end surface of the layer of the ultraviolet-curable resin is irradiated with ultraviolet rays emitted from a light emitting diode provided at an outermost circumferential side.

2. The method according to claim 1, wherein the number of light emitting diodes is increased from an inner circumferential side to an outer circumferential side.

3. (canceled)

4. The method according to claim 1, wherein, during the treatment, the layer of the ultraviolet-curable resin is irradiated with ultraviolet rays while rotating a laminated body having the layer of the ultraviolet-curable resin.

5. The method according to claim 2, wherein, during the treatment, the layer of the ultraviolet-curable resin is irradiated with ultraviolet rays while rotating a laminated body having the layer of the ultraviolet-curable resin.

6. The method according to claim 1, wherein, during the treatment, the layer of the ultraviolet-curable resin is irradiated with ultraviolet rays while rotating a laminated body having the layer of the ultraviolet-curable resin.

7. The method according to claim 1, wherein an angle formed between the surface of the layer of the ultraviolet-curable resin and the direction in which the ultraviolet rays are emitted from the light emitting diode provided at the outermost circumferential side is 20 to 50°.
